(19) United States
(12) Patent Application Publication
(10) Pub. No.: US 2024/0397412 A1
(43) Pub. Date: Nov. 28, 2024

(54) RADIO ACCESS NETWORK DISCOVERY IN 5G-AS-A-SERVICE OFFERINGS

(71) Applicant: Cisco Technology, Inc., San Jose, CA (US)

(72) Inventors: Somaraju Kaki, Bangalore (IN); Nithin Chitta, Bangalore (IN)

(21) Appl. No.: 18/322,208

(22) Filed: May 23, 2023

(51) Int. Cl. H04W 48/14; H04W 60/04

(52) U.S. Cl. CPC H04W 48/14; H04W 60/04

(57) ABSTRACT

A method, computer system, and computer program product are provided for providing 5G-as-a-Service. A network repository function is queried by a network management function to obtain identifying data for each of a plurality of radio base stations. A ping test is initiated by the network management function and based on the identifying data to be performed between at least one access and mobility management function (AMF) and each of the plurality of radio base stations to determine latencies between the at least one AMF and each of the plurality of radio base stations. A connection is initiated between the at least one AMF and a first radio base station of the plurality of radio base stations based on identifying a lowest latency between the at least one AMF and the first radio base stations.

### TECHNICAL FIELD

The present disclosure relates generally to radio networks, and more specifically, to Radio Access Network discovery in 5G-as-a-Service offerings.

### BACKGROUND

A Radio Access Network (RAN), in the context of 5G-as-a-Service (5GaaS), can include a 5G Radio Access Network. In particular, 5GaaS RANs enables communication service providers to offer 5G network access to their customers without the need to invest in expensive hardware and infrastructure. However, there are significant challenges with providing 5GaaS RAN architectures.

### BRIEF DESCRIPTION OF THE DRAWINGS

FIG. 1 is a block diagram of a network environment, according to an example embodiment.

FIG. 2 is a flow diagram of a process for connecting a radio base station with an access and mobility management function, according to an example embodiment.

FIG. 3 is a diagram of a graphical user interface for presenting network data to a user, according to an example embodiment.

FIG. 4 is a diagram of a graphical user interface for presenting network data to a user, according to an example embodiment.

FIG. 5 is a flow chart of a method of performing automated radio access network discovery, according to an example embodiment.

FIG. 6 is a block diagram of a device that may be configured to perform operations to automate RAN discovery, as presented herein.

### DETAILED DESCRIPTION

### Overview

According to one embodiment, techniques are provided for providing 5G-as-a-Service. A network repository function is queried by a network management function to obtain identifying data for each of a plurality of radio base stations. A ping test is initiated by the network management function and based on the identifying data to be performed between at least one access and mobility management function (AMF) and each of the plurality of radio base stations to determine latencies between the at least one AMF and each of the plurality of radio base stations. A connection is initiated between the at least one AMF and a first radio base station of the plurality of radio base stations based on identifying a lowest latency between the at least one AMF and the first radio base stations.

### Example Embodiments

Present embodiments relate to radio networks, and more specifically, to Radio Access Network (RAN) discovery in 5G-as-a-Service (5GaaS) offerings. The 5GaaS-RAN architecture consists of virtualized radio access network components that are deployed on cloud platforms. This architecture provides benefits of scalability, flexibility, and reduced time-to-market. However, service providers may not be provided with the visibility of network aspects that would be needed to automate deployments, thus forcing the service providers to perform manual configuring.

In a 5GaaS network, a gNodeB is the functional equivalent of a radio base station in a conventional cellular network; thus, gNodeBs are responsible for radio communication with user equipments (UEs) in its coverage area. A gNodeB can be a physical entity (e.g., a radio tower) or can be disaggregated, in a virtualized RAN (vRAN) architecture into a Radio Unit (RU), a distributed unit (DU), and a central or centralized unit (CU), thereby enabling a software-defined radio architecture. Another component of a 5GaaS network is an Access and Mobility Management Function (AMF), a core network entity that is responsible for managing the access and mobility of user devices. An AMF can be connected with one or more gNodeB in order to manage network resources, facilitate user equipment registrations with a network, and the like. The core network can include other entities, such as a Session Management Function (SMF), a user plane function (UPF), a Network Repository Function (NRF), a Policy Control Function (PCF), and other such elements as may be defined or otherwise provided by Third Generation Partnership Project (3GPP) standards.

In some deployments, a service provider is responsible for onboarding a RAN using another vendor's packet core, including AMFs. However, the service provider may be unaware of certain details regarding the connectivity between gNodeBs and AMFs. In particular, the service provider is not provided with latency data between gNodeBs and AMFs in conventional approaches, making it impossible to automate the onboarding process. Rather, gNodeB-to-AMF connections are typically established manually.

To address this problem, the embodiments presented herein provide an automated approach to onboarding a RAN into 5GaaS architecture.

Conventional network discovery protocols, such as Simple Network Management Protocol (SNMP), Network Configuration Protocol (NETCONF), Link Layer Discovery Protocol (LLDP), etc., each have several limitations. For example, SNMP may not include robust security features, NETCONF is not implemented into gNodeBs, and LLDP is suited for Ethernet devices.

Considering the challenges with the above protocols, embodiments herein provide implementing a 5G Service Based Interface (SBI)/Hypertext Transfer Protocol 2.0 (HTTP2) logic at gNodeBs to extend the functionality of the gNodeBs. The SBI/HTTP2 logic enables gNodeBs to perform registrations with an NRF thereby enabling the gNodeBs to be discovered by other network elements, which can enable the ability to determine the latencies between gNodeBs and AMFs in order to initiate connections based on their respective latency values. Thus, present embodiments improve the technical field of telecommunication by enabling RANs to be onboarded to a 5GaaS network in a fully-automated manner, providing the practical application of reducing costs and time required to configure while also increasing the efficiency of a deployment with regard to network resources by optimizing the selection of gNodeBs for AMFs.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

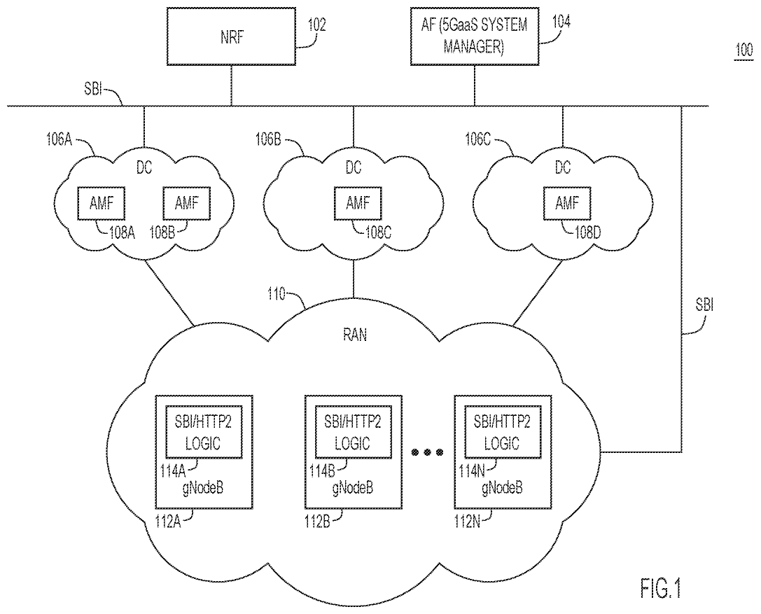

Embodiments will now be described in detail with reference to the Figures. Reference is now made to FIG. 1. FIG. 1 is a block diagram of a network environment 100, according to an example embodiment. As depicted, network environment 100 includes a Network Repository Function (NRF) 102, a 5GaaS System Manager 104, a plurality of Data Centers (DCs) 106A-106C, and a Radio Access Network (RAN) 110. Each DC 106A-106C may include one or more Access and Mobility Management Functions (AMFs) 108A-108D, and RAN 110 may include a plurality of gNodeBs 112A-112N, each of which implements SBI/HTTP2 logic 114A-114N.

It is to be understood that the functional division among components have been chosen for purposes of explaining various embodiments and is not to be construed as a limiting example. Each element of network environment 100 may be a physical entity or a virtual entity and may include one or more modules or units to perform various functions of the embodiments described below. Each element of network environment 100 may be implemented by any combination of any quantity of software and/or hardware modules or units.

NRF 102 is a core network entity of network environment 100 that provides a centralized repository for network functions and services. NRF 102 may maintain information about available network functions and services, including their locations and capabilities. The functions of NRF 102 can include service discovery, service registration, service capability exposure, load balancing, network slicing, and/or other functions and services. In particular, NRF 102 provides service registration by enabling network functions and services to register with the NRF, allowing them to be discovered by other network entities. Once a particular service or function is registered with NRF 102, other network entities can determine whether that particular service or function is available and/or suitable for their needs.

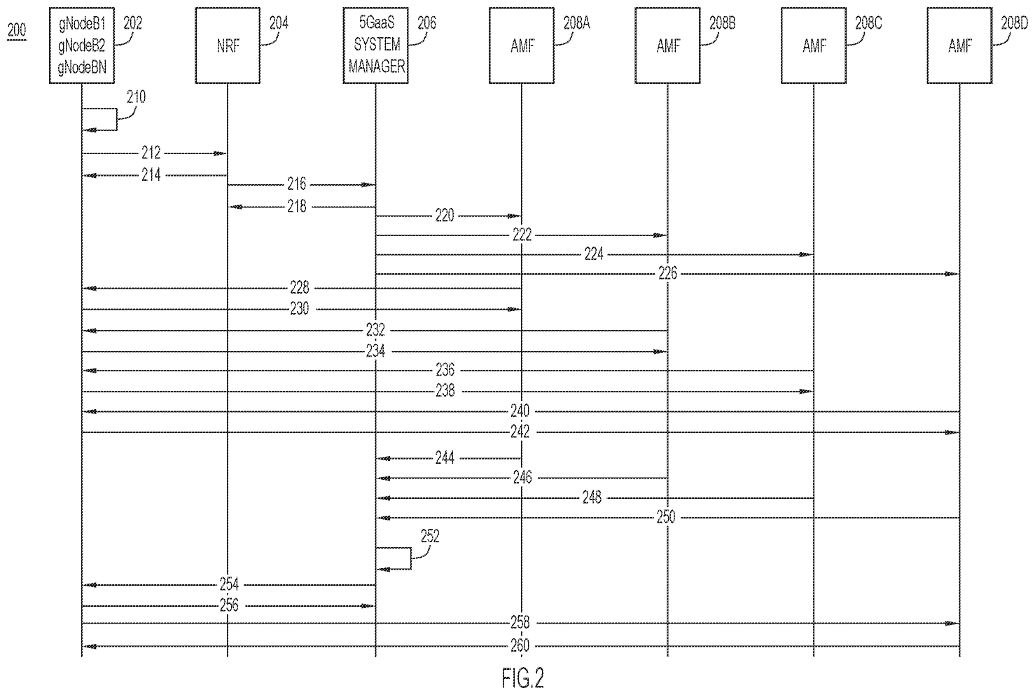

The 5GaaS System Manager 104 may be considered as an Application Function (AF) that may be responsible for providing application-specific functionality and services by integrating with NRF 102. In accordance with embodiments herein, the 5GaaS System Manager 104 may be considered a network management function that may interact with the core network and other network functions to provide a variety of services, such as authentication and authorization of user equipments (UEs) to access specific applications and services, session management, traffic management, service chaining, Quality of Service (QOS) management, analytics and reporting to network operators, and other tasks. In some embodiments, 5GaaS System Manager 104 is responsible for initiating the collection of latency data between AMFs 108A-108D and gNodeBs 112A-112N by obtaining or receiving data from NRF 102 to discover registered gNodeBs 112A-112N, which is depicted and described in further detail below with reference to FIG. 2.

DCs 106A-106C are data centers that may host core network functions and services, such as AMFs 108A-108D. Each DC 106A-106C may host one or more AMFs; as depicted, DC 106A includes at least AMFs 108A and 108B, DC 106B includes AMF 108C, and DC 106C includes AMF 108D. However, in various embodiments, there may be any number of data centers, each hosting any number of AMFs. Each DC 106A-106C may provide computing, storage, and networking resources that are required to support network functions and services of network environment 100. DCs 106A-106C may be physically located in various facilities, which may be secure, temperature-controlled, and provided with redundant power supplies and network connections. In addition to AMFs 108A-108N, DCs 106A-106C may host Session Management Functions (SMFs), User Plane Functions (UPFs), Policy Control Functions (PCFs), additional AFs and/or NRFs, and/or any other network functions (NFs) as may be applicable for 3GPP standards. Each DC 106A-106C may also provide virtualization technologies like Software-Defined Networking (SDN). Each DC 106A-106C may be connected to RAN 110 and other parts of the network through high-speed networking connections to ensure low latency and high throughput.

The AMFs 108A-108D hosted by DCs 106A-106C may be responsible for managing the access and mobility of user devices in the network. In various embodiments, AMFs 108A-108D may perform authentication and authorization of UEs to access network environment 100, as well as session management (by establishing and managing user sessions), mobility management (by tracking the location of UEs and managing handovers), security management (e.g., managing the security keys and certificates), QoS management, and/or policy enforcement. The AMF is to connect with one or more gNodeB for in order to facilitate UE registrations and facilitate mobility management for UEs. When UEs establish a connection with network environment 100 through any of gNodeBs, an AMF is responsible for managing the connection. This includes authenticating the user, setting up the security context, and managing the user's mobility as they move from one gNodeB to another. Additionally or alternatively, each AMF may be responsible for configuring gNodeB with the appropriate network parameters, such as QoS settings and access control policies. In some embodiments, each AMF may manage the allocation of network resources to user sessions by managing the radio resources allocated to the various gNodeB and ensuring that there is sufficient capacity to support the user sessions.

RAN 110 is a radio access network that includes a plurality of radio base stations (e.g., gNodeBs 112A-112N). AMFs 108A-108D are connected to gNodeBs 112A-112N such that UEs can connect to RAN 110 in order to access other portions of network environment 100 and/or other networks (e.g., the Internet). UEs that are connected to RAN 110 may be managed by policies that are provided by AMFs 108A-108D to gNodeBs 112A-112N so that UEs can be admitted to the network, handed over from one gNodeB to another, and the like.

Each gNodeBs 112A-112N may be a radio base station that supports a 5G network (e.g., network environment 100). gNodeBs 112A-112N may be physical or virtual, and each may support multiple UEs.

Unlike conventional gNodeBs, gNodeBs 112A-112N of the embodiments presented herein can be enhanced to include 5G Service Based Interface (SBI)/Hypertext Transfer Protocol 2.0 (HTTP2) logic (e.g., SBI/HTTP2 logic 114A-114N). Thus, gNodeBs 112A-112N may communicate using the HTTP2 protocol over SBI, which provides gNodeBs 112A-112N with access to NRF 102 and 5GaaS System Manager 104, as depicted. Thus, using SBI/HTTP2 logic 114A-114N, gNodeBs 112A-112N may register with NRF 102, providing data such as their network addresses (e.g., Internet Protocol (IP) addresses), location data (e.g., latitude and longitude coordinates), and/or any other desired data.

In accordance with embodiments herein, the SBI/HTTP2 logic 114A-114N may be a stack that can be defined according to various standards/specifications, such as those defined by Third Generation Partnership Project (3GPP) and/or Internet Engineering Task Force (IETF). In particular, the SBI/HTTP2 logic may implement any combination of the following technical specifications (TS): 3GPP TS 29.500 (“Technical Realization of Service Based Architecture”), IETF RFC 7540 (“Hypertext Transfer Protocol Version 2 (HTTP/2)”), 3GPP TS 29.510 (“5G System; Network Function Repository Services; Stage 3”), IETF RFC 8259 (“The JavaScript Object Notation (JSON) Data Interchange Format”), and/or IETF RFC 3986 (“Uniform Resource Identifier (URI): Generic Syntax”).

A service-based interface (SBI), as may be facilitated via SBI/HTTP2 logic 114A-114N, generally represents how a set of services is provided or exposed by a given NF (e.g., each of gNodeBs 112A-112N); thus, a service-based interface may be characterized as an interface in which NF service operations may be invoked. The 3GPP Service-Based Architecture (SBA) supports the NF Service Framework that enables the use of NF services, as specified in Section 7.1 of 3GPP TS 23.501. The NF Service Framework may include the following mechanisms: NF service registration and de-registration (enabling the NRF aware of the available NF instances and supported services (e.g., as prescribed via Section 7.1.5 of 3GPP TS 23.501)), NF service discovery (which may enable a NF Service Consumer to discover NF Service Producer instance(s) that provide the expected NF service(s) (e.g., as defined in Section 7.1.3 of 3GPP TS 23.501)), NF service authorization (which may ensure the NF Service Consumer is authorized to access the NF service provided by the NF Service Producer (e.g., as defined in subclause 7.1.4 of 3GPP TS 23.501)). The corresponding Stage 3 procedures are defined in 3GPP TS 29.510. Thus, in some embodiments, the service-based architecture may support the NF Service Framework that enables the use of NF services as specified in subclause 7.1 of 3GPP TS 23.501.

FIG. 2 is a flow diagram of a process 200 for connecting a radio base station with an access and mobility management function, according to an example embodiment. As depicted, process 200 involves interactions between a plurality of gNodeBs 202 (i.e., gNodeB1, gNodeB2, gNodeBN, etc.), an NRF 204, a 5GaaS System Manager 206, and AMFs 208A-208D. gNodeBs 202, NRF 204, 5GaaS System Manager 206, and/or AMFs 208A-208D may correspond to gNodeBs 112A-112N, NRF 102, 5GaaS System Manager, and AMFs 108A-108D, respectively, which are depicted and described with reference to FIG. 1. Only one gNodeB “element” (gNodeB 202) is shown in FIG. 2 for purposes of brevity only; it is to be understood that embodiments of the process 200 can involve operations performed with each of a plurality of gNodeBs in a manner consistent with the operations discussed herein for FIG. 2. Thus, reference may be made to “each gNodeB 202” for certain operations that may be performed in an iterative manner for each of multiple gNodeBs (e.g., gNodeB1, gNodeB2, through gNodeBN) that may be present/identified for a deployment.

Initially, SBI/HTTP2 logic is integrated into each gNodeB 202 at operation 210. In various embodiments, such integration may include configuring the SBI/HTTP2 logic at each gNodeB by a network administrator or, in some instances, such logic may be provided by a manufacturer, vendor, or the like for each gNodeB. By implementing the SBI/HTTP2 logic, the gNodeBs 202 may communicate with NRF 204. Next, at operation 212, each gNodeB 202 may register with NRF 204 by providing its IP address, a gNodeB identifier (e.g., an identifier unique to that gNodeB, such as a Cell Global Identifier (CGI)), and/or location data (e.g., latitude and longitude data). At operation 214, NRF 204 may reply back to each gNodeB 202 to indicate that registration was successful (otherwise, a gNodeB may make subsequent attempts to register).

By implementing SBI/HTTP2 logic at each gNodeB, the gNodeBs are provided with an ability such that, post bootstrap/logic integration, the gNodeBs can automatically share data with the NRF, including any combination of gNodeB identifiers, IP addresses, location data, status, Public Land Mobile Network (PLMN) identifying data such as Mobile Country Code (MCC) data, (Mobile Network Code) MNC data, etc., Tracking Area Code (TAC) data, and/or any other desired data. Embodiments herein may facilitate different levels of NRF registration functionality for each gNodeB 202. In some embodiments, a “lightweight” NRF registration functionality may be enabled for gNodeBs such that the SBI/HTTP2 logic configured for each gNodeB may permits each gNodeB to share its IP address, gNodeB identifier, and latitude/longitude with NRF 204. In other embodiments, the SBI/HTTP2 logic may be implemented in a “full-featured” manner to facilitate more complete NRF registration functional that may permit each gNodeB to share any desired data with the NRF 204

Continuing with process 200, as shown at operation 216, 5GaaS System Manager 206 transmits a request to NRF 204 to obtain data relating to the registered gNodeBs 202. The data may include all or a subset of the data maintained by NRF 204, such as IP addresses, geolocations, gNodeB identifiers, and/or additional data. NRF 204 may transmit a response at operation 218 that includes the requested data. Thus, 5GaaS System Manager 206 may obtain data relating to gNodeBs 202 via the SBI/HTTP2 logic that is implemented in each gNodeB 202. This data enables AMFs 208A-208D to ping gNodeBs 202 so that latency data can be collected: as depicted, 5GaaS System Manager 206 initiates the process of collecting latency data by transmitting instructions to each AMF 208A-208D at operations 220, 222, 224, and 226. These instructions cause each AMF 208A-208D to ping every gNodeB 202 (or alternatively, a subset of gNodeBs) to determine the latency. Thus, at operation 228, AMF 208A initiates a ping to each gNodeB 202, each of which can reply with a ping response at operation 230. It is to be understood that operations at 228 and 230 can involve initiating a ping with each of multiple gNodeBs and obtaining responses from each of the gNodeBs. Similarly, AMF 208B and gNodeBs 202 perform a ping at operations 232 and 234, AMF 208C and gNodeBs 202 perform a ping at operations 236 and 238, and AMF 208D and gNodeBs 202 perform a ping at operations 240 and 242.

Thus, latency data (e.g., round-trip-times) can be obtained for each combination of AMF 208A-208D and each of a given gNodeB 202. This data can be provided from AMFs 208A-208D to 5GaaS System Manager 206 at operations 244, 246, 248, and 250. Once the data is received, 5GaaS System Manager 206 many analyze the data at operation 252. The latency data can be provided to 5GaaS System Manager 206 by each AMF 208A-208D. This latency data is analyzed at operation 252 to identify the combinations of one or more gNodeBs 202 for each AMF 208A-208D that has the lowest latency. In some embodiments, a graphical user interface may be generated to present the data visually to a user. For example, a table may be generated that shows the latency values; the table may be sorted by latency so that the lowest latency values are at the top of the table, for example. Additionally or alternatively, a map may be presented that illustrates a geographical area that is labeled with respect to the geographical location of each gNodeB 202, which can be selected to present additional data (e.g., latency data, gNodeB identifier, latitude and longitude, status, IP address, etc.). A particular AMF of AMFs 208A-208D can be automatically selected for a particular gNodeB 202 (e.g., gNodeB2) based on having a lowest latency, and then automatically connected. Operations 220-252 may be iteratively for each gNodeB 202 until each gNodeB 202 has conducted a ping test.

In the example embodiment of FIG. 2, consider that AMF 208D may be determined to have a lowest latency for a particular gNodeB 202. Thus, at operation 254, 5GaaS System Manager 206 transmits an instruction to that gNodeB 202 to invoke a configuration Application Programming Interface (API) and to configure the gNodeB 202 for connectivity with AMF 208D. At operation 256, the gNodeB 202 transmits a response back to 5GaaS System Manager 206 to indicate that the configuration is successful. Next, the particular gNodeB 202 (e.g., gNodeB2) sends a request at operation 258 for AMF 208D to connect, and AMF 208D replies at operation 260 to cause the particular gNodeB 202 to connect with AMF 208D. In at least one embodiment, the operation at 252 may involve the particular gNodeB 202 sending a 3GPP standards-based Next Generation Application Protocol (NGAP) setup request to the AMF 208D to which the AMF 208D can respond with an NGAP setup response indicating successful connection between the particular gNodeB 202 and the AMF 208D.

Similarly, operations analogous to the operations of 244-252 may be performed for each gNodeB iteratively until the gNodeBs 202 are all assigned an AMF 208A-208D. Additionally, some or all of the operations of process 200 may be repeatedly performed according to a predetermined schedule or on an ad hoc basis to ensure that the resulting network configuration remains updated.

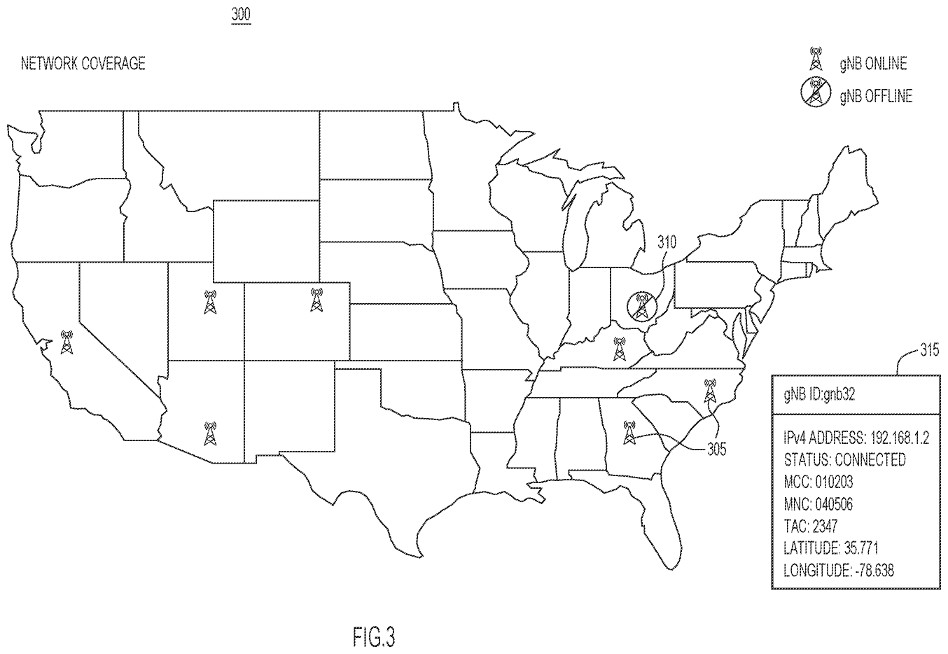

FIG. 3 is a diagram of a graphical user interface 300 for presenting network data to a user, according to an example embodiment. As depicted, a plurality of gNodeBs are depicted with respect to their geographical locations. Each gNodeB can be labeled with respect to its status: as shown, gNodeBs 305 are online, whereas gNodeB 310 is offline. When a particular gNodeB is selected, graphical user interface 300 automatically presents data regarding that gNodeB. For example, table 315 is a user interface element of a selected gNodeB that has an identifier of “gnb32,” an IP address of “192.168.1.2,” a status of “connected,” a MCC of “010203,” a MNC of “040506,” a TAC of “2347,” a latitude of “35.771,” and a longitude of “−78.638.” This data may be obtained in accordance with present embodiments by virtue of providing the SBI/HTTP2 logic at each gNodeB.

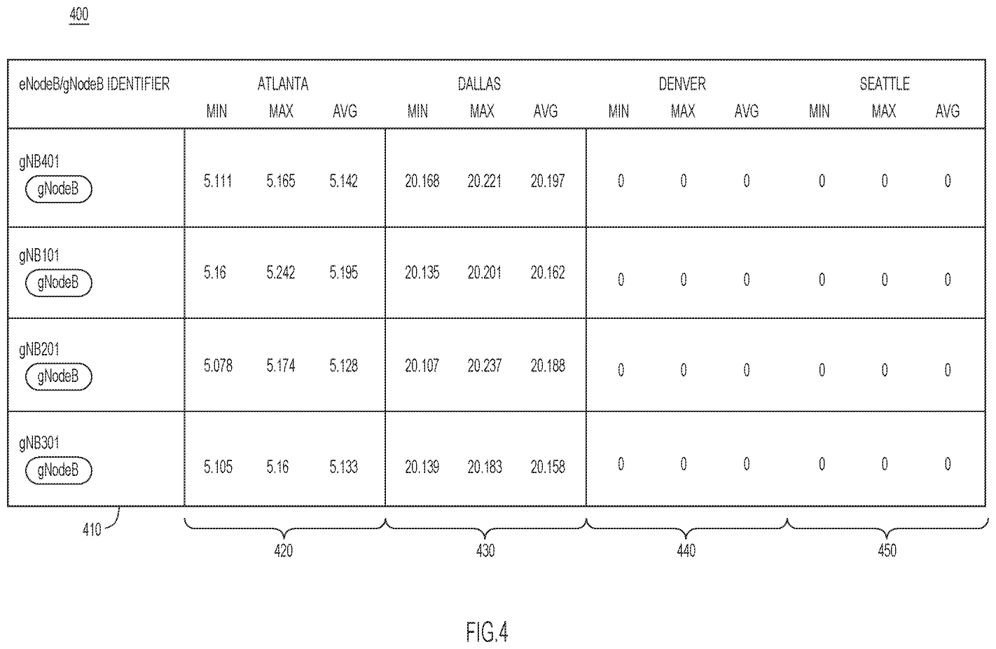

FIG. 4 is a diagram of a graphical user interface 400 for presenting network data to a user, according to an example embodiment. Graphical user interface 400 is a table that presents data that is obtained using the SBI/HTTP2 logic that is implemented at gNodeBs, for example, using a process as discussed for FIG. 2 to gather latency data between each of a gNodeB registered with an NRF and each of an AMF/DC with each gNodeB may be connected. As depicted, the data includes gNodeBs 410 and latency data 420-450 for corresponding AMFs at four locations. The latency data can be color-coded or provided with another identifier to visually represent which location has the best (i.e., lowest-latency) AMF. In the depicted example, latency data 420 is the lowest, indicating that the AMF in Atlanta is the optimal AMF to select. Latency data 430 indicates that Dallas has higher latency than Atlanta, and latency data 440 and 450 indicates that the AMF(s) in Denver and Seattle is/are offline.

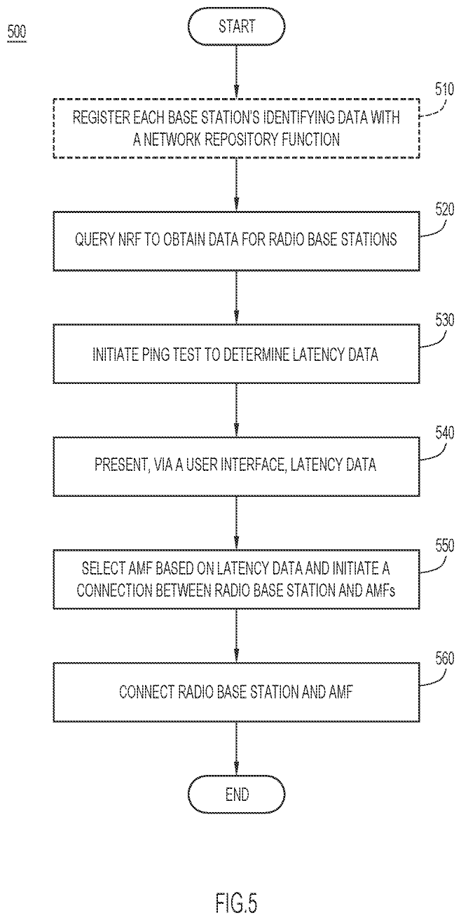

FIG. 5 is a flow chart of a method 500 of performing automated radio access network discovery, according to an example embodiment.

Initially, each base station's identifying data is registered with a network repository function at operation 510. Operation 510 may be optional, as operation 510 may only be required once, whereas the other operations of method 500 may be repeated to repeatedly execute method 500 without requiring a subsequent execution of operation 510. The data may be obtained by registering each radio base station (e.g., gNodeB) with an NRF over SBI using the HTTP2 protocol. By implementing SBI/HTTP2 logic at each gNodeB, the gNodeBs are provided with the ability to automatically share data with the NRF, including gNodeB identifiers, IP addresses, location data, status, MCC data, MNC data, TAC data, and/or any other desired data. In some embodiments, a lightweight functionality is provided to the gNodeBs that implements the minimal amount of logic necessary to permit each gNodeB to share its IP address, gNodeB identifier, and latitude/longitude. In other embodiments, the SBI/HTTP2 logic provides complete functionality, enabling gNodeBs to share any desired data with an NRF.

The NRF is queried to obtain data for radio base stations at operation 520. Once the gNodeBs are registered with the NRF, the NRF can maintain data relating to each gNodeB. For example, a 5GaaS System Manager (a network management function) can then query the NRF to obtain the necessary data to perform a ping test, which may include at least the IP addresses of the gNodeBs and the AMFs. Geolocation data may also be considered; in some embodiments, AMFs may be omitted from consideration if the distance between an AMF and gNodeB exceeds a predetermined threshold distance.

A ping test is initiated to determine latency data at operation 530. The 5GaaS System Manager may instruct each AMF to ping each gNodeB. When a reply is received by each AMF, the AMF can provide the round-trip time to the 5GaaS System Manager. Once the ping test is completed, the latency data is presented via a user interface at operation 540. The data can be presented in a table that uses visual indicators to indicate the latency values. For example, low latency values may be depicted in a green color, and high latency values may be depicted in an orange or red color. Additionally or alternatively, a map may be presented that depicts the geographical location of AMFs and/or gNodeBs, along with accompanying latency data and/or other data.

An AMF is selected (e.g., by the 5GaaS System Manager) based on the latency data between the radio base station and the AMFs at operation 550. The data may be analyzed to identify, for each gNodeB, one or more AMFs to connect having a lowest latency. The selected radio base station is then connected to the selected AMF at operation 560. For example, the 5GaaS System Manager can trigger the selected radio base station to perform an NGAP setup with the selected AMF. Thus, gNodeBs and AMFs may be automatically connected without requiring any manual configuration. Accordingly, embodiments herein may help 5GaaS vendors to have improved RAN network visibility and may also assist service providers in selecting appropriate data centers and NFs out of many available in a 5GaaS cloud for implementing an end-to-end network deployment.

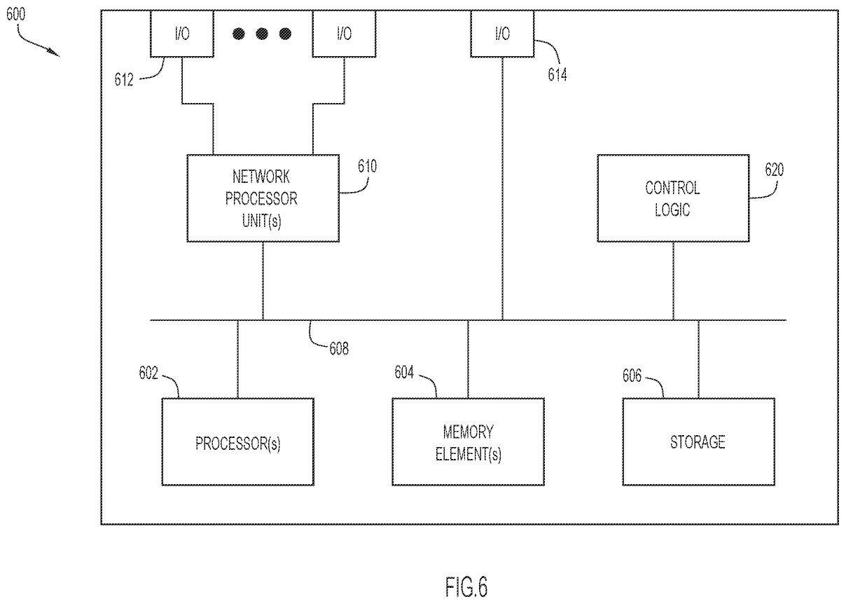

Referring now to FIG. 6, FIG. 6 illustrates a hardware block diagram of a computing device 600 that may perform functions associated with operations discussed herein in connection with the techniques depicted in FIGS. 1-5. In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O 614, and 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O 614 allow for input and output of data and/or information with other entities that may be connected to computing device 600. For example, I/O 614 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of,’ one or more of, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X. Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method for providing 5G-as-a-Service including: querying, by a network management function, a network repository function to obtain identifying data for each of a plurality of radio base stations; initiating, by the network management function and based on the identifying data, a ping test to be performed between at least one access and mobility management function (AMF) and each of the plurality of radio base stations to determine latencies between the at least one AMF and each of the plurality of radio base stations; and initiating a connection between the at least one AMF and a first radio base station of the plurality of radio base stations based on identifying a lowest latency between the at least one AMF and the first radio base stations.

In some aspects, the techniques described herein relate to a method, wherein each radio base station of the plurality of radio base stations is a gNodeB.

In some aspects, the techniques described herein relate to a method, wherein Service Based Interface (SBI)/HTTP2 logic is provided for each of plurality of radio base stations.

In some aspects, the techniques described herein relate to a method, wherein the SBI/HTTP2 logic enables each radio base station to register the identifying data within the network repository function.

In some aspects, the techniques described herein relate to a method, wherein the identifying data includes a network address and an identifier for each radio base station.

In some aspects, the techniques described herein relate to a method, wherein the identifying data includes latency data or location data for each radio base station.

In some aspects, the techniques described herein relate to a method, further including displaying, by the network management function, a map indicating a location of each radio base station in relation to a location of each AMF.

In some aspects, the techniques described herein relate to a method, further including displaying a table identifying the latencies between each AMF and each corresponding radio base station.

In some aspects, the techniques described herein relate to a system including: one or more computer processors; one or more computer readable storage media; and program instructions stored on the one or more computer readable storage media for execution by at least one of the one or more computer processors, the program instructions including instructions to: query, by a network management function, a network repository function to obtain identifying data for each of a plurality of radio base stations; initiate, by the network management function and based on the identifying data, a ping test to be performed between at least one access and mobility management function (AMF) and each of the plurality of radio base stations to determine latencies between the at least one AMF and each of the plurality of radio base stations; and initiate a connection between the at least one AMF and a first radio base station of the plurality of radio base stations based on identifying a lowest latency between the at least one AMF and the first radio base stations.

In some aspects, the techniques described herein relate to a system, wherein each radio base station of the plurality of radio base stations is a gNodeB.

In some aspects, the techniques described herein relate to a system, wherein Service Based Interface (SBI)/HTTP2 logic is provided for each of plurality of radio base stations.

In some aspects, the techniques described herein relate to a system, wherein the SBI/HTTP2 logic enables each radio base station to register the identifying data within the network repository function.

In some aspects, the techniques described herein relate to a system, wherein the identifying data includes a network address and an identifier for each radio base station.

In some aspects, the techniques described herein relate to a system, wherein the identifying data includes latency data or location data for each radio base station.

In some aspects, the techniques described herein relate to a system, wherein the program instructions further include instructions to display, by the network management function, a map indicating a location of each radio base station in relation to a location of each AMF.

In some aspects, the techniques described herein relate to a system, wherein the program instructions further include instructions to display a table identifying the latencies between each AMF and each corresponding radio base station.

In some aspects, the techniques described herein relate to one or more non-transitory computer readable storage media having program instructions embodied therewith, the program instructions executable by a computer to cause the computer to perform operations including: query, by a network management function, a network repository function to obtain identifying data for each of a plurality of radio base stations; initiate, by the network management function and based on the identifying data, a ping test to be performed between at least one access and mobility management function (AMF) and each of the plurality of radio base stations to determine latencies between the at least one AMF and each of the plurality of radio base stations; and initiate a connection between the at least one AMF and a first radio base station of the plurality of radio base stations based on identifying a lowest latency between the at least one AMF and the first radio base stations.

In some aspects, the techniques described herein relate to one or more non-transitory computer readable storage media, wherein each radio base station of the plurality of radio base stations is a gNodeB.

In some aspects, the techniques described herein relate to one or more non-transitory computer readable storage media, wherein Service Based Interface (SBI)/HTTP2 logic is provided for each of plurality of radio base stations.

In some aspects, the techniques described herein relate to one or more non-transitory computer readable storage media, wherein the SBI/HTTP2 logic enables each radio base station to register the identifying data within the network repository function.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
querying, by a network management function, a network repository function to obtain identifying data for each of a plurality of radio base stations;
initiating, by the network management function and based on the identifying data, a ping test to be performed between at least one access and mobility management function (AMF) and each of the plurality of radio base stations to determine latencies between the at least one AMF and each of the plurality of radio base stations; and
initiating a connection between the at least one AMF and a first radio base station of the plurality of radio base stations based on identifying a lowest latency between the at least one AMF and the first radio base stations.

2. The method of claim 1, wherein each radio base station of the plurality of radio base stations is a gNodeB.

3. The method of claim 1, wherein Service Based Interface (SBI)/HTTP2 logic is provided for each of plurality of radio base stations.

4. The method of claim 3, wherein the SBI/HTTP2 logic enables each radio base station to register the identifying data within the network repository function.

5. The method of claim 1, wherein the identifying data includes a network address and an identifier for each radio base station.

6. The method of claim 1, wherein the identifying data includes latency data or location data for each radio base station.

7. The method of claim 1, further comprising displaying, by the network management function, a map indicating a location of each radio base station in relation to a location of each AMF.

8. The method of claim 1, further comprising displaying a table identifying the latencies between each AMF and each corresponding radio base station.

9. A system comprising:
one or more computer processors;
one or more computer readable storage media; and
program instructions stored on the one or more computer readable storage media for execution by at least one of the one or more computer processors, the program instructions comprising instructions to:
query, by a network management function, a network repository function to obtain identifying data for each of a plurality of radio base stations;
initiate, by the network management function and based on the identifying data, a ping test to be performed between at least one access and mobility management function (AMF) and each of the plurality of radio base stations to determine latencies between the at least one AMF and each of the plurality of radio base stations; and
initiate a connection between the at least one AMF and a first radio base station of the plurality of radio base stations based on identifying a lowest latency between the at least one AMF and the first radio base stations.

10. The system of claim 9, wherein each radio base station of the plurality of radio base stations is a gNodeB.

11. The system of claim 9, wherein Service Based Interface (SBI)/HTTP2 logic is provided for each of plurality of radio base stations.

12. The system of claim 11, wherein the SBI/HTTP2 logic enables each radio base station to register the identifying data within the network repository function.

13. The system of claim 9, wherein the identifying data includes a network address and an identifier for each radio base station.

14. The system of claim 9, wherein the identifying data includes latency data or location data for each radio base station.

15. The system of claim 9, wherein the program instructions further comprise instructions to display, by the network management function, a map indicating a location of each radio base station in relation to a location of each AMF.

16. The system of claim 9, wherein the program instructions further comprise instructions to display a table identifying the latencies between each AMF and each corresponding radio base station.

17. One or more non-transitory computer readable storage media having program instructions embodied therewith, the program instructions executable by a computer to cause the computer to perform operations including:
query, by a network management function, a network repository function to obtain identifying data for each of a plurality of radio base stations;
initiate, by the network management function and based on the identifying data, a ping test to be performed between at least one access and mobility management function (AMF) and each of the plurality of radio base stations to determine latencies between the at least one AMF and each of the plurality of radio base stations; and
initiate a connection between the at least one AMF and a first radio base station of the plurality of radio base stations based on identifying a lowest latency between the at least one AMF and the first radio base stations.

18. The one or more non-transitory computer readable storage media of claim 17, wherein each radio base station of the plurality of radio base stations is a gNodeB.

19. The one or more non-transitory computer readable storage media of claim 18, wherein Service Based Interface (SBI)/HTTP2 logic is provided for each of plurality of radio base stations.

20. The one or more non-transitory computer readable storage media of claim 19, wherein the SBI/HTTP2 logic enables each radio base station to register the identifying data within the network repository function.
